(19) United States
(12) Patent Application Publication
(10) Pub. No.: US 2024/0222884 A1
(43) Pub. Date: Jul. 4, 2024

(54) TRACER WIRE JUMPERS AND PIGTAILS

(71) Applicant: Hubbell Incorporated, Shelton, CT (US)

(72) Inventors: John Kenneth Carrozzo, Jr, Torrington, CT (US); Stephen Andrew Skolozdra, Terryville, CT (US)

(21) Appl. No.: 18/558,456

(22) PCT Filed: May 3, 2022
(86) PCT No.: PCT/US2022/027431

§ 371 Date: Nov. 1, 2023

Related U.S. Application Data
(60) Provisional application No. 63/183,320, filed on May 3, 2021.

(51) Int. Cl. H01R 4/2433; F16L 1/11

(52) U.S. Cl. CPC H01R 4/2433; F16L 1/11

(57) ABSTRACT

Tracer wire jumper assemblies include a first tracer wire connector, a second tracer wire connector and a jumper wire between the first tracer wire connector and the second tracer wire connector. Each tracer wire connector has housing and at least one contact assembly. The housing includes a base and a cover that is movably secured to the base. The cover is movable between a closed position and an open position. The contact assembly includes a termination portion and at least one contact. The jumper wire has each end electrically connected to the termination portion of one of the tracer wire connectors. Tracer wire pigtail assemblies include a tracer wire connector and a pigtail wire. The tracer wire connector has a housing. The housing includes a base and a cover. The cover is movably secured to the base so that the cover is movable between a closed position and an open position. The base also includes a contact assembly having a termination portion and at least one contact. The pigtail wire has a first end electrically connected to the termination portion of the contact assembly and a free second end.

### CROSS-REFERENCE TO RELATED APPLICATIONS

The present application is based on and claims benefit from U.S. Provisional Application No. 63/183,320, which was filed on May 3, 2021 and is entitled “Tracer Wire Jumpers and Pigtails” the entire contents of which are incorporated herein by reference.

### BACKGROUND

### Field

The present disclosure relates generally to electrical pigtails and jumpers used to maintain continuity of tracer wires at certain junctions along a run of a tracer wire. More specifically, the present disclosure relates to tracer wire pigtails and jumpers used to maintain continuity of tracer wires associated with underground duct systems.

### Description of the Related Art

Tracer wires are used when underground objects that are not electrically conductive need to be located after being buried. Such non-conductive objects include High Density Polyethylene (HDPE) ducts through which, for example, telecommunication cabling, and electrical cabling pass. Since such non-conductive underground ducts are difficult to detect and locate from above the ground, an electrical conductor, such as a tracer wire, is attached to the duct. Knowing the existence of a tracer wire in proximity to a non-conductive underground duct allows technicians to locate the non-conductive underground duct by passing electrical current through the tracer wire and sensing the electrical field with an above ground detector, or by detecting the presence of the metallic cable forming the tracer wire. However, such non-conductive underground ducts have a fixed length and are joined together using couplers. At the coupler joint, the tracer wires from the two non-conductive underground ducts are typically joined using a wire nut and then the wire nut is sealed to prevent water from damaging the electrical connection. Connecting the wire nuts at each coupler joint and sealing each wire nut is time consuming increasing the cost to install the non-conductive underground ducts. The Tracer wire jumpers and pigtails provide a faster more economically way to joint tracer wires.

### SUMMARY

The present disclosure provides embodiments of electrical jumpers and pigtails used to maintain continuity of tracer wires at certain junctions along a run of a tracer wire, such as tracer wires running along underground duct systems. In an exemplary embodiment, the tracer wire jumper assembly includes a first tracer wire connector, a second tracer wire connector and a jumper wire between the first tracer wire connector and the second tracer wire connector. The first tracer wire connector has a first base and a first cover that is movably secured to the first base so that the first cover is movable between a closed position and an open position. The first base includes a first contact assembly that includes a termination portion and at least one contact. Preferably, the first contact assembly includes a plurality of contacts. The second tracer wire connector has a second base and a second cover that is movably secured to the second base so that the second cover is movable between a closed position and an open position. The second base includes a second contact assembly having a termination portion and at least one contact. Preferably, the second contact assembly includes a plurality of contacts. The jumper wire has a first end electrically connected to the termination portion of the first contact assembly and a second end electrically connected to the termination portion of the second contact assembly.

In another exemplary embodiment, the tracer wire jumper assembly includes a first tracer wire connector, a second tracer wire connector and a jumper wire between the first tracer wire connector and the second tracer wire connector. The first tracer wire connector includes a first housing and at least one first contact assembly positioned within the first housing. The first housing has a first cover movable between a closed position and an open position. The at least one first contact assembly has at least one first contact configured to pierce or cut through a non-conductive material surrounding a first tracer wire so that the at least one first contact can electrically contact the first tracer wire when the first cover is in the closed position. The second tracer wire connector includes a second housing and at least one second contact assembly positioned within the second housing. The second housing has a second cover movable between a closed position and an open position. The at least one second contact assembly has at least one second contact configured to pierce or cut through a non-conductive material surrounding a second tracer wire so that the at least one second contact can electrically contact the second tracer wire when the second cover is in the closed position. The jumper wire has a first end electrically connected to the at least one first contact assembly, and a second end electrically connected to the at least one second contact assembly.

In an exemplary embodiment, the tracer wire pigtail assembly includes a tracer wire connector and a pigtail wire. The tracer wire connector has a base and a cover. The cover is movably secured to the base so that the cover is movable between a closed position and an open position. The base includes a contact assembly having a termination portion and at least one contact. The pigtail wire has a first end electrically connected to the termination portion of the contact assembly and a free second end that may include a terminal connector, such as a spade-type terminal connector or a ring-type terminal connector.

In another exemplary embodiment, the tracer wire pigtail assembly includes a tracer wire connector and a pigtail wire. The tracer wire connector has a housing and at least one contact assembly positioned within the housing. The housing has a cover movable between a closed position and an open position. The at least one contact assembly has at least one contact configured to pierce or cut through a non-conductive material surrounding the tracer wire so that the at least one contact can electrically contact the tracer wire when the cover is in the closed position. The pigtail wire has a first end electrically connected to the at least one contact assembly and a free second end. The free second end of the pigtail wire may include a terminal connector, such as a spade-type terminal connector or a ring-type terminal connector.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a perspective view of an exemplary embodiment of an underground duct system with a tracer wire, illustrating two underground ducts each with an integral tracer wire and joined by a coupler, and a tracer wire jumper connected to the tracer wires and spanning the coupler, and illustrating a tracer wire pigtail connected to the tracer wire at an end of one of the two underground ducts;

FIG. 2 is an exploded perspective view of the underground duct system with a tracer wire of FIG. 1;

FIG. 3 is a perspective view of an exemplary embodiment of a tracer wire jumper assembly according to the present disclosure, illustrating two tracer wire connectors electrically connected to an electrical wire;

FIG. 4 is a side elevation view of the tracer wire jumper assembly of FIG. 3;

FIG. 5 is a perspective view of an exemplary embodiment of a tracer wire pigtail assembly according to the present disclosure, illustrating a tracer wire connector connected to one end of an electrical wire and a spade-type or ring-type terminal connector connected to the other end of the electrical wire;

FIG. 6 is a perspective view of an exemplary embodiment of a tracer wire connector according to the present disclosure, illustrating a housing having a cover in an open position, an electrical wire positioned for connection to an electrical contact assembly within a body of the tracer wire connector, with multiple contacts used to pierce insulating material encasing the tracer wire that is integral with the underground duct of FIG. 1;

FIG. 7 is an exploded perspective view of the tracer wire connector of FIG. 6;

FIG. 8 is a perspective view of an exemplary embodiment of an electrical contact assembly within the body of the tracer wire connector of FIG. 6, illustrating tapered-type piercing edges of contacts of the electrical contact assembly;

FIG. 9 is a side elevation view of the tracer wire connector of FIG. 6 with the cover in an open position and the tracer wire connector positioned for connecting to a tracer wire that is integral with the underground duct of FIG. 1;

FIG. 10 is a side elevation view of the tracer wire connector of FIG. 9 with the cover moving to a closed position and prior to the contacts of the tracer wire connector piercing the insulation material surrounding the tracer wire that is integral with the underground duct of FIG. 1;

FIG. 11 is a side elevation view of the tracer wire connector of FIG. 10 with the cover in the closed position so that the contacts of the tracer wire connector pierced through the insulation material surrounding the tracer wire that is integral with the underground duct; and

FIG. 12 is an enlarged view of a portion of the tracer wire connector and underground duct of FIG. 11 taken from detail 12 and illustrating the contacts of the tracer wire connector cutting through the insulating material surrounding the tracer wire that is integral with the underground duct and the tracer wire in electrical contact with the contacts to form an electrically conductive path between the tracer wire and the contact assembly of the tracer wire connector.

### DETAILED DESCRIPTION

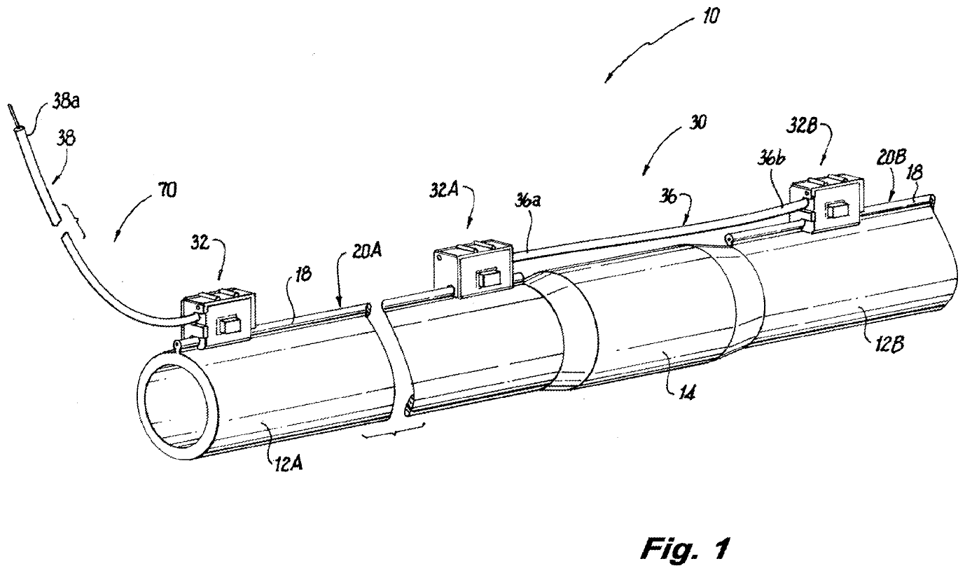

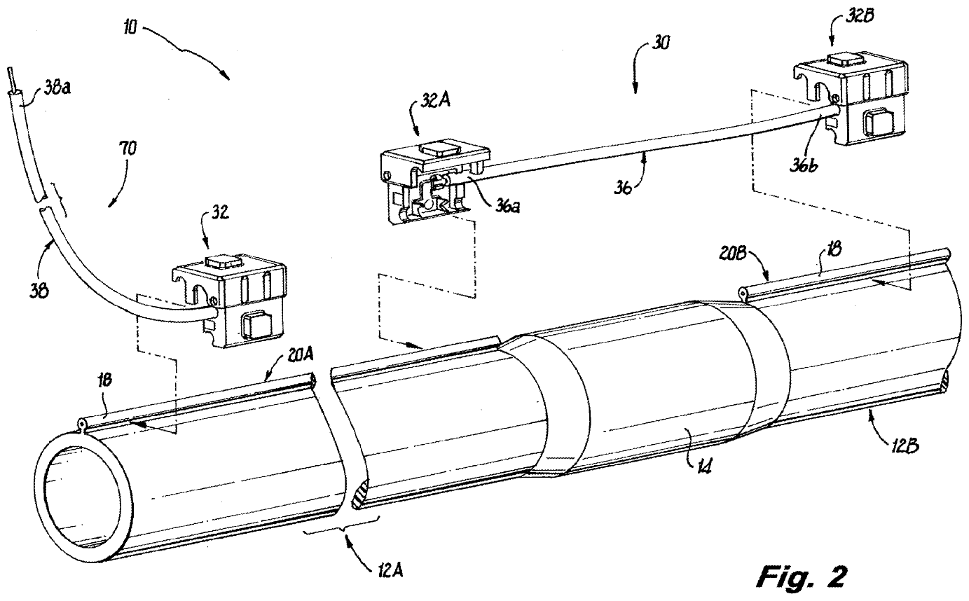

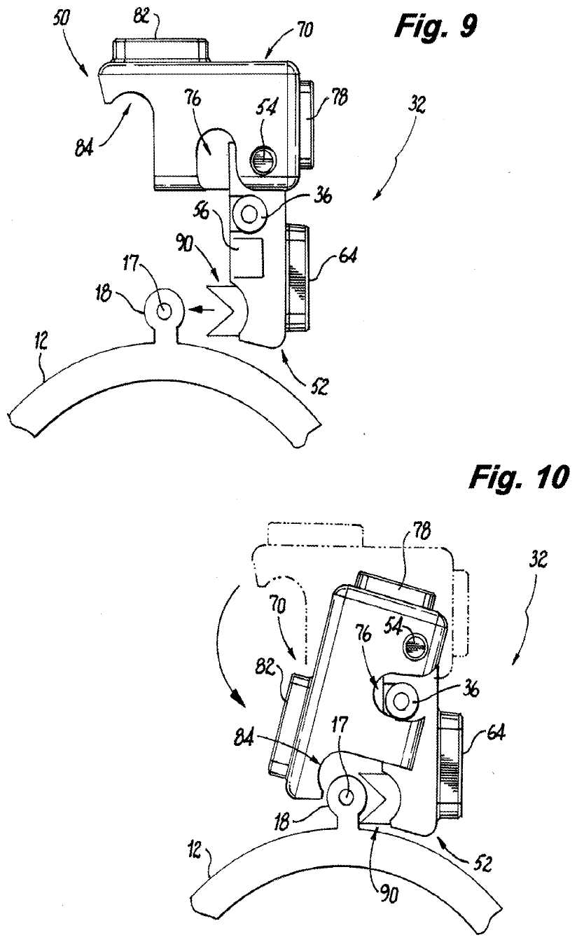

The present disclosure provides embodiments of trace wire pigtail assemblies and tracer wire jumper assemblies used to maintain continuity of tracer wires at certain junctions along a run of a tracer wire integral with non-conductive underground duct systems. For ease of description, the non-conductive underground duct systems described herein may also be referred to herein as the “duct systems” in the plural and the “duct system” in the singular. An example of a duct system 10 according to the present disclosure is shown in FIGS. 1 and 2. In the exemplary embodiment shown, the duct system 10 includes a first non-conductive duct 12A, a second non-conductive duct 12B and a non-conductive coupler 14 joining the first non-conductive duct 12A to the second non-conductive duct 12B. It is noted that the non-conductive ducts 12A and 12B are the same and may generally referred to herein as the non-conductive duct 12, and when distinguishing between the non-conduct ducts they may be referred to with an alpha-numeric reference, e.g., 12A or 12B. Each non-conductive duct 12 includes a tracer wire 17, seen in FIG. 9, encased within a non-conductive material 18 that is attached to or otherwise formed to an exterior surface of the non-conductive duct 12. For ease of description, the tracer wire 17 encased within the non-conductive material 18 may also be referred to herein generally as the tracer wire assembly 20. Non-limiting examples of non-conductive ducts with an integral tracer wire assembly include the PINPOINT® buried duct and the Locatable Microduct duct both sold by Dura-Line Corporation, Knoxville, TN. The PINPOINT® and Locatable Microduct ducts are made of High Density Polyethylene (HDPE). For ease of description, when distinguishing between different tracer wire assemblies 20, reference may be made to an alpha-numeric reference, e.g., 20A or 20B. The duct system 10 according to the present disclosure may also include a tracer wire jumper assembly 30 attached to a first end portion of tracer wire assembly 20A and a second end portion of tracer wire assembly 20B. For ease of description, the tracer wire jumper assemblies 30 may also be referenced herein as the “jumper assemblies” in the plural and the “jumper assembly” in the singular. The duct system 10 may also include a tracer wire pigtail assembly 70 attached to a second end portion of the tracer wire assembly 20A. For ease of description, the tracer wire pigtail assemblies 70 may also be referenced herein as the “pigtail assemblies” in the plural and the “pigtail assembly” in the singular.

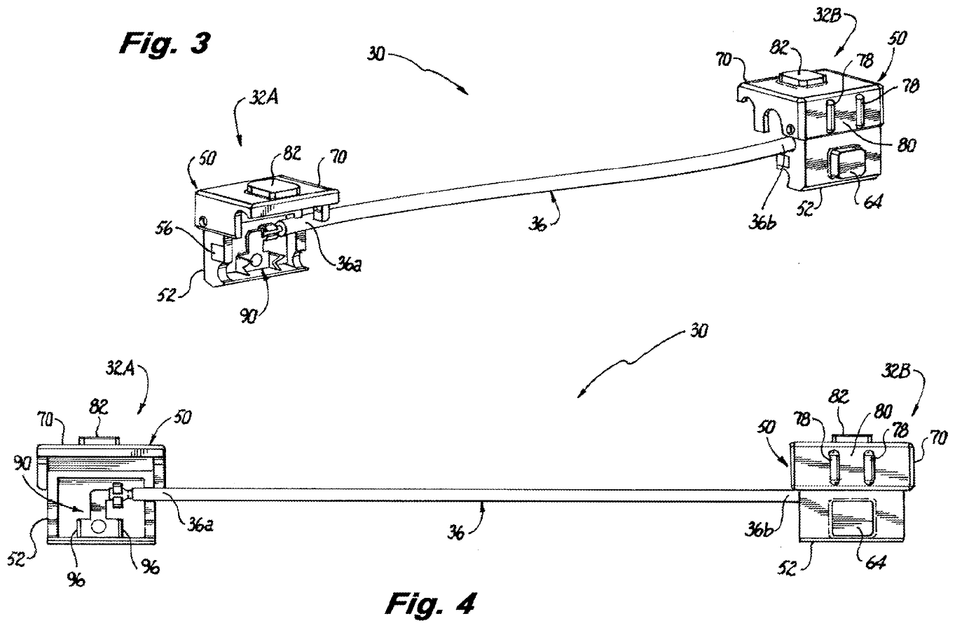

Referring to FIGS. 3 and 4, each jumper assembly 30 according to the present disclosure includes a pair of tracer wire connectors 32 and an electrical wire 36 between the pair of tracer wire connectors. In the exemplary embodiment shown in FIGS. 3 and 4, the jumper assembly 30 includes a first tracer wire connector 32A, a second tracer wire connector 32B and an electrical wire 36 between the first tracer wire connector 32A and the second tracer wire connector 32B. Preferably, the electrical wire 36 is an insulated electrical wire, and may also be referred to herein as the “jumper wire”. As a non-limiting example, a length of the jumper wire 36 may range from about 3 inches and about 20 inches. A first end portion 36a of the jumper wire 36 is electrically connected to the first tracer wire connector 32A, and a second end portion 36b of the jumper wire 36 is electrically connected to the second tracer wire connector 32B. Each jumper assembly 30 is used to maintain continuity of the tracer wires 17, seen in FIGS. 9 and 10, within the tracer wire assemblies 20 associated with the non-conductive underground duct system 10.

Each exemplary pigtail assembly 70 shown in FIG. 5, includes a tracer wire connector 32 and an electrical wire 38 extending from and electrically connected to the tracer wire connector 32. Preferably, the electrical wire 38 is an insulated electrical wire, and may also be referred to herein as a “pigtail wire”. As a non-limiting example, a length of the pigtail wire 38 may range from about 6 inches and about 20 feet. The free end 38a of the pigtail wire 38 may include a terminal connector 40 attached thereto. As a non-limiting example, FIG. 5 depicts a spade-type terminal connector 40 that may be attached to the free end 38a of the pigtail wire 38. As another non-limiting example, FIG. 5 also depicts a ring-type terminal connector 40 that may be attached to the free end 38a of the pigtail wire 38. The pigtail assemblies 70 can be used to connect the tracer wire 17 to, for example, utility marker posts, utility pedestals, utility cabinets, utility manholes, utility cable vaults, utility enclosures, and utility handholes.

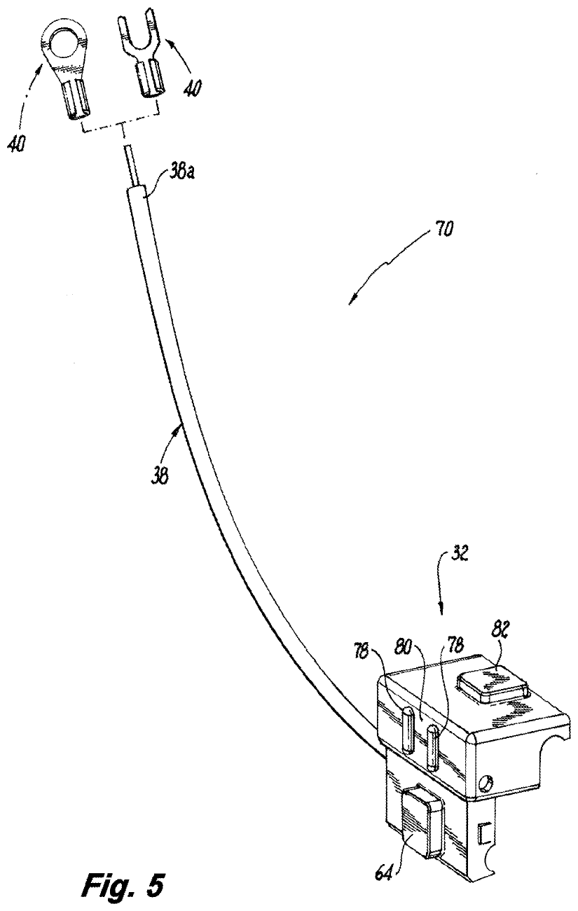

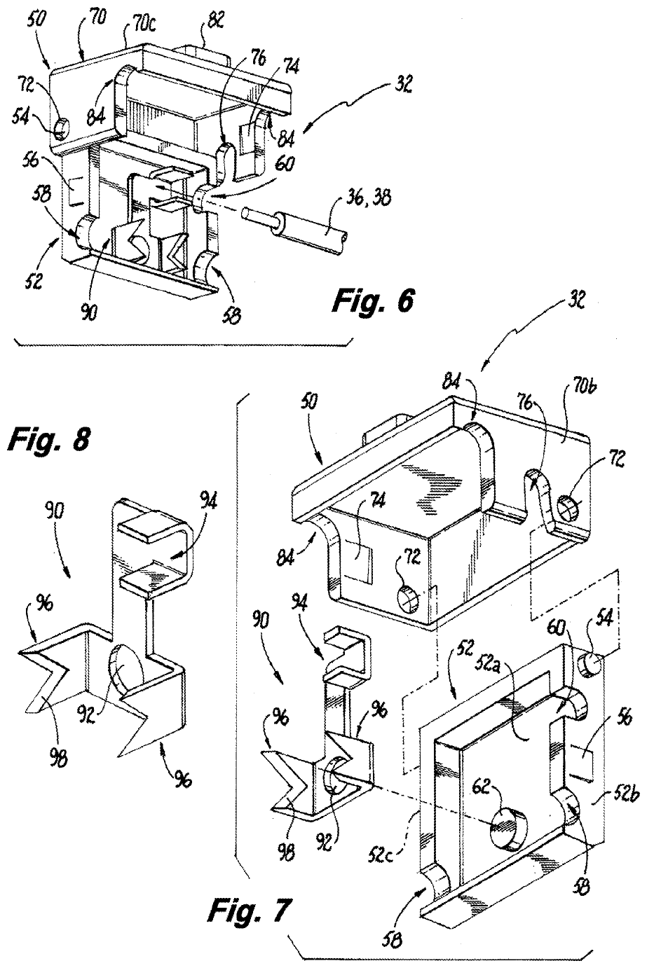

Referring now to FIGS. 6-8, an exemplary embodiment of the tracer wire connector 32 according to the present disclosure is shown. For ease of description, the tracer wire connector 32 may also be referred to herein as the “connector” in the singular and the “connectors” in the plural. The connector 32 includes a housing 50 having a base 52 and a cover 70. An upper portion of the base 52 has two cover mounting tabs 54 that extend outwardly from the side walls 52b and 52c of the base. Each cover mounting tab 54 is configured and dimensioned to fit within a corresponding mounting aperture 72 in the cover 70, as described in more detail below. In this exemplary embodiment, each side wall 52b and 52c of the base 52 may also include a snap-tab 56 that is configured and dimensioned to fit within notches 74 in the cover 70, as described in more detail below. In this exemplary embodiment, each of the side walls 52b and 52c of the base 52 may also include a pass-through notch 58 that is configured and dimensioned to receive at least partially a tracer wire assembly 20, as described in more detail below. The side wall 52c of the base 52 may also include a wire notch 60 that is configured and dimensioned to receive the jumper wire 36 or the pigtail wire 38. To seal the housing 50 to limit and possibly prevent moisture from seeping into the housing 50, a sealing gel may be applied to an interior of the base 52 such that when the cover 70 is in the closed position, seen in FIG. 1, the sealing gel spreads throughout the interior of the housing 50 sealing any openings in the housing 50 and the electrical connections therein. The sealing gel may be, for example, a weatherproof sealing gel such as a silicone-based gel.

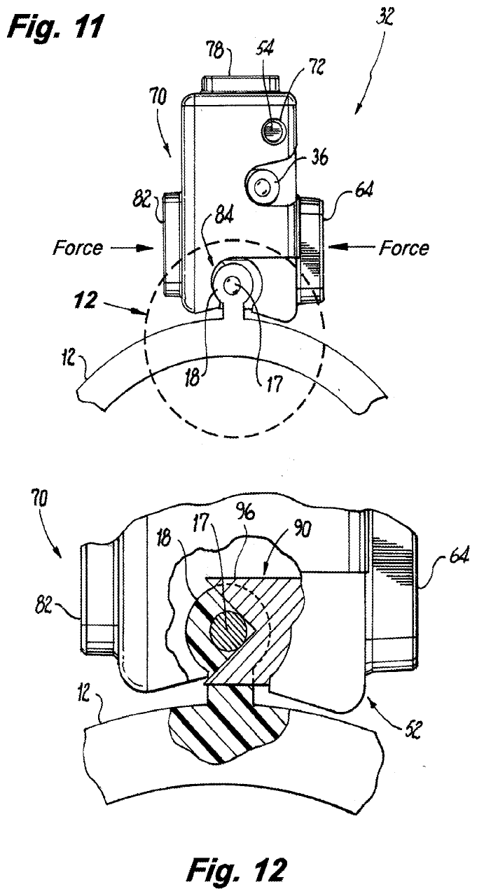

Continuing to refer to FIGS. 6-8, the base 52 has a contact assembly 90 mounted to an interior wall 52a by, for example, press fitting the contact assembly 90 onto a boss 62 extending from an interior surface 52a of the base 52 via an opening 92 in the contact assembly 90. The contact assembly 90 is made of an electrically conductive material, such as copper, aluminium or brass. The contact assembly 90 includes a wire termination portion 94 where the jumper wire 36 or the pigtail wire 38 can be electrically connected to the contact assembly 90. The contact assembly 90 also includes a one or more contacts 96. Each of the one or more contacts 96 are configured and dimensioned to pierce or cut through the non-conductive material 18 encasing the tracer wire 17, seen in FIGS. 10 and 12, that is attached to or otherwise formed to an exterior surface of the non-conductive duct 12. In the exemplary embodiment of FIGS. 7 and 8, each contact 96 is a V-shaped member having a pair of pointed teeth configured and dimensioned to pierce or cut through the non-conductive material 18 encasing the tracer wire 17 and flat walls configured to contact the tracer wire 17 encased within the non-conductive material 18. In the exemplary embodiment of FIG. 8, each contact 60 is a V-shaped member configured and dimensioned with a tapered edge that forms a cutting blade edge to pierce or cut through the non-conductive material 18 encasing the tracer wire 17 and contacts the tracer wire 17 encased within the non-conductive material 18, as shown in FIG. 12. In the exemplary embodiment of FIG. 8, each contact 96 is a V-shaped member configured and dimensioned with tapered edges 98 and a pointed tip that forms a cutting blade edge to pierce or cut through the non-conductive material 18 encasing the tracer wire 17 and contacts the tracer wire 17 encased within the non-conductive material 18, as seen in FIGS. 10-12. However, the contacts 96 may come in other configurations that permit the contacts 96 to cut through or pierce the non-conductive material 18 encasing the tracer wire 17 so that the contacts 96 can make electrical contact with the tracer wire 17. In some instances, the non-conductive material 18 encasing the tracer wire 17 of the non-conductive duct 12 may be made of a harder material, such as High Density Polyethylene (HDPE), polyethylene and polyolefins copolymers. In such instances, the contacts 96 may need to be made of a harder material, such as copper alloys and stainless steel, that is capable of cutting through or piercing the non-conductive material 18 encasing the tracer wire 17 so that the contacts 96 can make electrical contact with the tracer wire 17.

Referring to FIGS. 6 and 7, the cover 70 of the housing 50 is preferably attached to the base 52 so that the cover 70 is movable, e.g., rotatable or pivotable, between a closed position, seen in FIG. 1, and an open position, seen in FIG. 6. In the exemplary embodiment shown, the cover 70 is pivotably secured to the base 52. The side walls 70a and 70b of the cover 70 include mounting apertures 72 that are configured and dimensioned to receive the corresponding cover mounting tabs 54 extending from the side walls 52b and 52c of the base 52. The cover mounting tabs 54 act as pivot points permitting the cover 70 to pivot between the closed position and the open position. To lock the cover 70 in the closed position, inside surfaces of the side walls 70a and 70b of the cover 70 include notches 74 that are configured and dimensioned to receive corresponding snap-tabs 56 extending from outside surfaces of the side walls 52b and 52c of the base 52. The side wall 70b of the cover 70 includes a wire slot 76 configured and dimensioned to receive the jumper wire 36 or the pigtail wire 38 when the cover is in the closed position, and a tracer wire slot 84 configured and dimensioned to receive the non-conductive material 18 that is attached to or otherwise formed to an exterior surface of the non-conductive duct 12, as seen in FIGS. 10 and 11. The wall of the tracer wire slot 84 may also acts as a pressure plate when moving the cover 70 to the closed position. More specifically, the wall of the tracer wire slot 84 may contact the non-conductive material 18 encasing the tracer wire 17 to apply pressure to the non-conductive material 18 while to contacts 96 cut through or pierce the non-conductive material 18 as the cover 70 is moved to the closed position. At least a top surface 70c of the cover 70 may include one or more bosses 78 that has or forms a channel-like structure or track 80, seen in FIGS. 3 and 4. In this exemplary embodiment, the track 80 is configured and dimensioned to position and receive, for example, a tie-wrap used to supplement securing the tracer wire connectors 32 to the non-conductive duct 12.

Referring again to Figs, 3 and 4, the base 52 may include a boss 64 extending from an outer surface of the base, and the cover 70 may include a corresponding boss 82 extending from an outer surface of the cover. The bosses 64 and 82 are positioned on the base 52 and cover 70 so that a tool, such as Channellock tongue and groove pliers (not shown), can be positioned to grip the bosses 64 and 82 and squeeze the base 52 and cover 70 to the closed position. The bosses 64 and 82 may be solid or hollow members and are provided to help the base 52 and cover 70 withstand the force applied by the tool when squeezing the base 52 and cover 70 closed to minimize or possibly prevent damage to the base 52 and/or cover 70. The force applied by the tool on the bosses 64 and 82 assists the contacts 98 in cutting through or piercing the non-conductive material 18 encasing the tracer wire 17 so that the contacts 96 can make electrical contact with the tracer wire 17.

Installing tracer wire connectors 32 onto a tracer wire assembly 20 is described with reference to FIGS. 9-12. Installing tracer wire connectors 32 onto a tracer wire assembly 20 is achieved by pivoting the cover 70 of the housing 50 to the open position, seen in FIG. 9. The non-conductive material 18 of the tracer wire assembly 20 encasing the tracer wire 17 is positioned to align with the pass-through notches 58 in the side walls 52b and 52c of the base 52. The cover 70 is then pivoted toward the closed position, seen in FIG. 10, so that the contacts 96 cut through or pierce the the non-conductive material 18 encasing the tracer wire 17 until the snap-tabs 56 on each side wall 52b and 52c of the base 52 snap into their corresponding notches 74 in the cover 70 at which point the cover 70 is in the closed position, seen in FIG. 11. When the cover 70 is pivoted into the closed position, the contacts 96 pierce or cut through the non-conductive material 18 encasing the tracer wire 17 so that the contacts 96 are in electrical contact with the tracer wire 17 creating an electrical path between the tracer wire 17 and the jumper wire 36 or the pigtail wire 38 via the wire termination portion 94 and the contacts 96 of the contact assembly 56. In the event a tool (not shown) is used to move the cover 70 to the closed position, the tool would be positioned to grip the bosses 64 and 82. The tool would be activated, e.g., squeezed, to apply a force onto the bosses 64 and 82, seen in FIG. 11, assisting the contacts 98 in cutting through or piercing the non-conductive material 18 encasing the tracer wire 17 so that the contacts 96 can make electrical contact with the tracer wire 17. As noted above, if used the sealing gel would also spread throughout the interior of the housing 50 sealing any openings in the housing 50 and the electrical connections therein.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A tracer wire jumper assembly for electrically connecting tracer wires of two non-conductive ducts, the tracer wire jumper assembly comprising:
a first tracer wire connector having a first housing and at least one first contact assembly positioned within the first housing, the first housing having a first cover movable between a closed position and an open position, the at least one first contact assembly having at least one first contact configured to pierce or cut through a non-conductive material surrounding a first tracer wire so that the at least one first contact can electrically contact the first tracer wire when the first cover is in the closed position;
a second tracer wire connector having a second housing and at least one second contact assembly positioned within the second housing, the second housing having a second cover movable between a closed position and an open position, the at least one second contact assembly having at least one second contact configured to pierce or cut through a non-conductive material surrounding a second tracer wire so that the at least one second contact can electrically contact the second tracer wire when the second cover is in the closed position; and
a jumper wire having a first end electrically connected to the at least one first contact assembly and a second end electrically connected to the at least one second contact assembly.

2. The tracer wire jumper assembly according to claim 1, wherein the first housing includes a first base and the first cover, wherein the first cover is movably attached to the first base, and the second housing includes a second base and the second cover, wherein the second cover is movably attached to the second base.

3. The tracer wire jumper assembly according to claim 1, wherein the at least one first contact assembly comprises a termination portion and at least one contact in electrical communication with the termination portion.

4. The tracer wire jumper assembly according to claim 3, wherein the first end of the jumper wire is electrically connected to the termination portion of the at least one first contact assembly.

5. The tracer wire jumper assembly according to claim 1, wherein the at least one second contact assembly comprises a termination portion and at least one contact in electrical communication with the termination portion.

6. The tracer wire jumper assembly according to claim 5, wherein the second end of the jumper wire is electrically connected to the termination portion of the at least one second contact assembly.

7. The tracer wire jumper assembly according to claim 1, wherein first housing includes at least one boss extending from an outer surface of the first housing, and the second housing includes at least one boss extending from an outer surface of the second housing.

8. A tracer wire jumper assembly for electrically connecting tracer wires of two non-conductive ducts, the tracer wire jumper assembly comprising:
a first tracer wire connector having a first base and a first cover movably secured to the first base such that the first cover is movable between a closed position and an open position, the first base including a first contact assembly configured to pierce or cut through non-conductive material of a first of the two non-conductive ducts when the first cover is moved to the closed position;
a second tracer wire connector having a second base and a second cover movably secured to the second base such that the second cover is movable between a closed position and an open position, the second base including a second contact assembly configured to pierce or cut through non-conductive material of a second of the two non-conductive ducts when the second cover is moved to the closed position; and
a jumper wire having a first end electrically connected to the first contact assembly and a second end electrically connected to the second contact assembly.

9. The tracer wire jumper assembly according to claim 8, wherein the first contact assembly comprises a termination portion and at least one contact, and wherein the second contact assembly comprises a termination portion and at least one contact.

10. The tracer wire jumper assembly according to claim 9, wherein the first end of the jumper wire is electrically connected to the termination portion of the first contact assembly, and wherein the second end of the jumper wire is electrically connected to the termination portion of the second contact assembly.

11. The tracer wire jumper assembly according to claim 8, wherein first base includes at least one boss extending from an outer surface of the first base, wherein the first cover includes at least one boss extending from an outer surface of the first cover, wherein second base includes at least one boss extending from an outer surface of the second base, and wherein the second cover includes at least one boss extending from an outer surface of the second cover.

12. A tracer wire pigtail assembly for electrically connecting to a tracer wire of a non-conductive duct, the tracer wire pigtail assembly comprising:
a tracer wire connector having a housing and at least one contact assembly positioned within the housing, the housing having a cover movable between a closed position and an open position, the at least one contact assembly having at least one contact configured to pierce or cut through a non-conductive material surrounding the tracer wire so that the at least one contact can electrically contact the tracer wire when the cover is in the closed position; and
a pigtail wire having a first end electrically connected to the at least one contact assembly and a free second end.

13. The tracer wire pigtail assembly according to claim 12, wherein the housing includes a base and the cover, and wherein the cover is movably attached to the first base.

14. The tracer wire pigtail assembly according to claim 12, wherein the at least one contact assembly comprises a termination portion and at least one contact in electrical communication with the termination portion.

15. The tracer wire pigtail assembly according to claim 14, wherein the first end of the pigtail wire is electrically connected to the termination portion of the at least one contact assembly.

16. The tracer wire jumper assembly according to claim 12, wherein housing includes at least one boss extending from an outer surface of the housing.

17. A tracer wire pigtail assembly for electrically connecting to a tracer wire of a non-conductive duct, the tracer wire pigtail assembly comprising:
a tracer wire connector having a base and a cover movably secured to the base such that the cover is movable between a closed position and an open position, the base including a contact assembly configured to pierce or cut through non-conductive material of the non-conductive duct when the cover is moved to the closed position; and
a pigtail wire having a first end electrically connected to the termination portion of the contact assembly and a free second end.

18. The tracer wire pigtail assembly according to claim 17, wherein the contact assembly comprises a termination portion and at least one contact.

19. The tracer wire pigtail assembly according to claim 18, wherein the first end of the pigtail wire is electrically connected to the termination portion of the contact assembly.

20. The tracer wire jumper assembly according to claim 17, wherein base includes at least one boss extending from an outer surface of the base, and wherein the cover includes at least one boss extending from an outer surface of the cover.
